(19) United States
(12) Patent Application Publication
(10) Pub. No.: US 2026/0002386 A1
(43) Pub. Date: Jan. 1, 2026

(54) VEHICLE DOOR ASSEMBLIES FOR VEHICLES INCLUDING HANDLE SPRING MODULE

(71) Applicant: Toyota Motor Engineering & Manufacturing North America, Inc., Plano, TX (US)

(72) Inventors: Justin B. Norris, Brighton, MI (US); James D. Cunningham, Clarkston, MI (US)

(73) Assignees: Toyota Motor Engineering & Manufacturing North America, Inc., Plano, TX (US); Toyota Jidosha Kabushiki Kaisha, Toyota-shi (JP)

(21) Appl. No.: 18/756,589

(22) Filed: Jun. 27, 2024

(51) Int. Cl. E05B 77/04; E05B 79/20

(52) U.S. Cl. CPC E05B 77/04; E05B 79/20

(57) ABSTRACT

A vehicle includes a vehicle door assembly that includes a vehicle door assembly including a door interior handle assembly including a primary spring that biases a door interior handle toward a latched position and a door latch assembly. One or more cables where at least one cable of the one or more cables operably connects the door interior handle to the door latch assembly. A spring module is operably connected to the door interior handle by the one or more cables such that the spring module provides a secondary biasing force that biases the door interior handle toward the latched position.

### TECHNICAL FIELD

The present specification generally relates to vehicle door assemblies for vehicles and, more specifically, to vehicle door assemblies including handle spring modules.

### BACKGROUND

Door latch assemblies for vehicles may be provided and are used to latch a vehicle door, such as a driver side door or a passenger side door in a closed position. The door latch assemblies may include a door latch device within the vehicle door that can engage a cooperating structure, such as a striker that is located on a frame of the vehicle. The vehicle door may remain in the closed position until a vehicle occupant actuates a door handle, which then opens the door latch device.

For some side impact tests, vehicle door structures may move inboard, which may affect operation of the door latch and handle assemblies. What is desired are structures that can block unintended actuation of the door latch and handle assemblies under certain side impact conditions.

### SUMMARY

In one embodiment, a vehicle includes a vehicle door assembly that includes a vehicle door assembly including a door interior handle assembly including a primary spring that biases a door interior handle toward a latched position and a door latch assembly. One or more cables where at least one cable of the one or more cables operably connects the door interior handle to the door latch assembly. A spring module is operably connected to the door interior handle by the one or more cables such that the spring module provides a secondary biasing force that biases the door interior handle toward the latched position.

In another embodiment, a method of controlling unlatching of a vehicle door latch assembly is provided. The method includes connecting a spring module to at least one cable. The at least one cable operably connecting to a door interior handle including a primary spring that biases a door interior handle toward a latched position. The spring module is configured to provide a secondary biasing force that biases the door interior handle toward a latched position. The spring module is mounted inside the vehicle door assembly.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 is a diagrammatic interior view of a vehicle door assembly of a vehicle including a spring module, according to one or more embodiments shown and described herein;

FIG. 2 is a side view of the spring module for the vehicle door assembly of FIG. 1, according to one or more embodiments shown and described herein;

FIG. 3 is a front view of the spring module of FIG. 2, according to one or more embodiments shown and described herein;

FIG. 4 is a side view of the spring module of FIG. 2 with a panel removed, according to one or more embodiments shown and described herein;

FIG. 5 is a section view of the spring module of FIG. 2 along line A-A, according to one or more embodiments shown and described herein;

FIG. 6 is a diagrammatic interior view of another vehicle door assembly including spring module, according to one or more embodiments shown and described herein;

FIG. 7 illustrates another embodiment of a spring module with panel removed, according to one or more embodiments shown and described herein; and

FIG. 8 illustrates another embodiment of a spring module with panel removed, according to one or more embodiments shown and described herein.

### DETAILED DESCRIPTION

Embodiments described herein are generally related to vehicles that include a vehicle door assembly including a door interior handle assembly including a primary spring that biases a door interior handle toward a latched position and a door latch assembly. One or more cables where at least one cable of the one or more cables operably connects the door interior handle to the door latch assembly. A spring module is operably connected to the door interior handle by the one or more cables such that the spring module provides a secondary biasing force to bias the door interior handle toward the latched position.

During certain side impact conditions, vehicle door structures within the vehicle door assemblies can move inboard and other directions. Movement of the vehicle door structures can include the door interior handle and door latch assembly. To inhibit unintended movement of the door interior handle and door latch assembly, the spring module is provided. The spring module applies a secondary biasing force to the door interior handle in addition to a primary biasing force that is provided by a primary spring in the door interior handle assembly. The spring module can be provided in-line with or parallel to the cable that connects the door interior handle to the door latch assembly.

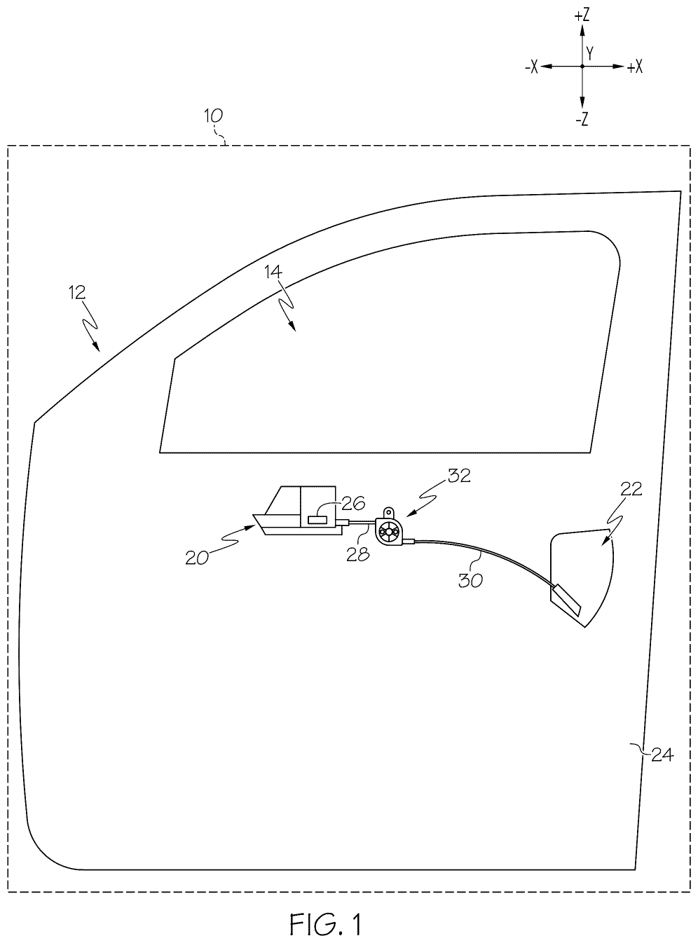

As used herein, the term “vehicle longitudinal direction” refers to the forward-rearward direction of the vehicle (i.e., in the +/−vehicle X-direction depicted in FIG. 1). The term “vehicle lateral direction” refers to the cross-vehicle direction of the vehicle (i.e., in the +/−vehicle Y-direction depicted in FIG. 1), and is transverse to the vehicle longitudinal direction. Further, the terms “inboard” and “outboard” are used to describe the relative positioning of various components relative to a centerline of the vehicle. Because the vehicle structure of the vehicle may be generally symmetrical about the vehicle centerline, the use of terms “inboard” and “outboard” may be switched when evaluating components positioned along opposite sides of the vehicle.

Referring to FIG. 1, a vehicle, represented by element 10, includes a vehicle door assembly 12, a window 14 and a door latch assembly 22. The window 14 can move up and down between an open configuration and a closed configuration. A door reinforcement beam mat be provided, such as a dent reinforcement that reinforces the vehicle door assembly 12 during various impacts. In the illustrated example, the vehicle door assembly 12 may be a front driver's door; however, the door latch assembly 22 may be equally applicable to any of the vehicle doors, including a rear door (e.g., of an SUV, van, etc.). It should be noted that the position of the door reinforcement beam 18 may vary depending on the make and model of a specific vehicle.

The vehicle door 12 may include an outer panel and one or more inner panels 24 that are connected to the outer panel to define a volume therebetween. The outer panel may be an outer visible panel of the vehicle body 10, while the inner panel 24 may be an interior door trim panel that is visible from inside the vehicle 10. The door latch assembly 22 may be located at least partially within the volume between the outer panel and the inner panel 24 of the vehicle door 12. The door latch assembly 22 may be operatively coupled to a door interior handle 20 that can be used to move the door latch assembly 22 between the unlatched and latched configurations for opening and closing the vehicle door 12 against the vehicle body. The door latch assembly 22 may be moved from the latched to the unlatched configuration by manually tugging on the door interior handle 20 that may be biased outward toward the latched configuration by a primary spring, represented by element 26. Tugging on the door interior handle 20 pulls one or more cables 28 and 30 that are connected to the door latch assembly 22, which actuates the door latch assembly 22 from the latched configuration to the unlatched configuration. The primary spring 26 provides a primary biasing force to the door interior handle 30, which inhibits unintended movement of the door interior handle 20 and, in turn, the door latch assembly 22 during a side impact.

A spring module 32 is connected to the cables 28 and 30. In this embodiment, the spring module 32 is connected directly to the cable 28 that is connected to the vehicle door handle 30. In this regard, the spring module 32 can be considered in-line with the cables 28 and 30 that connect the door interior handle 20 to the door latch assembly 22. In particular, the cable 28 extends between the spring module 32 and the door interior handle 20 and the cable 30 extends between the spring module 32 and the door latch assembly 22.

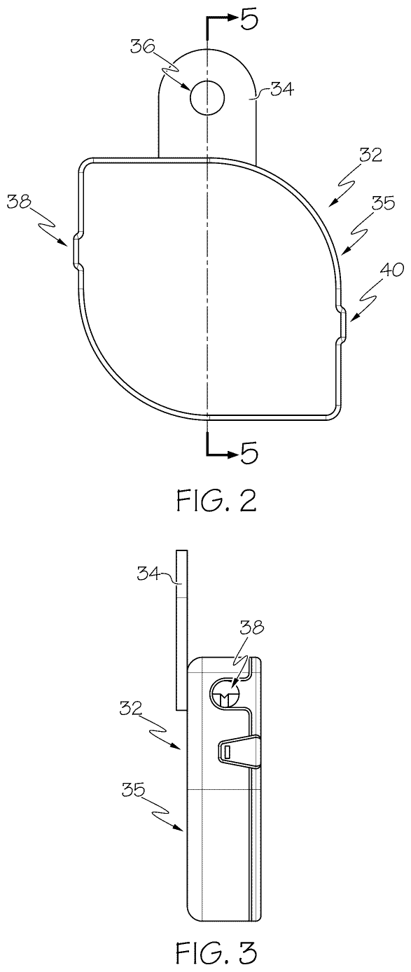

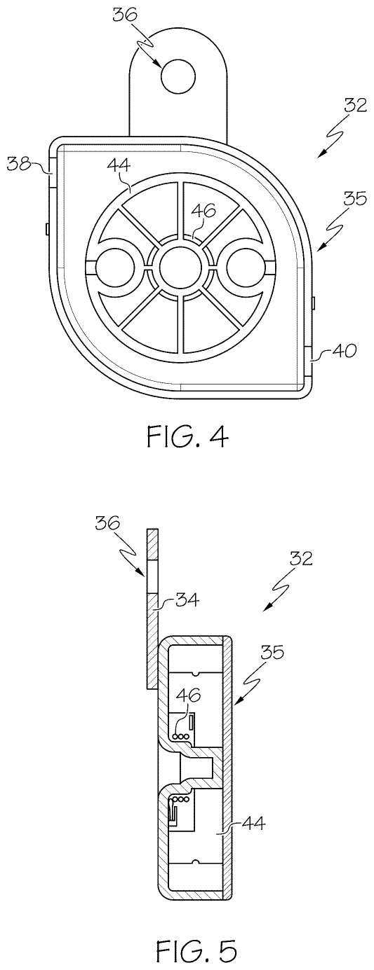

Referring to FIGS. 2-5, the spring module 32 includes an outer casing 25 that can include a mounting flange 34 with an opening 36 for mounting the spring module 32 to the outer and/or inner panel 24 and cable openings 38 and 40 through which the cables 28 and 30 extend. Referring to FIGS. 4 and 5 showing a view with side panel 42 removed and a section view, respectively, the spring module includes a cable drum 44 around which the cables 28 and 30 (FIG. 1) can be wound and a secondary spring 46, in this instance a torsion spring, that can be used to bias the cable drum and provide the secondary biasing force through the cable 28 and to the door interior handle 20 toward an initial position. With the door interior handle 20 in the initial position, the door latch assembly 22 is not actuated to the unlatched position by the door interior handle 20 and a greater force is required to move the door interior handle 20 than would be needed using the primary spring 26. In particular, in the case of FIG. 1, the total opposing spring rate is

$${K}_{1} + {K}_{2} ,$$

where
K₁ is the spring rate of the primary spring 26 and K₂ is the spring rate of the secondary spring 46.

When a vehicle experiences an impact, vehicle structures may elastically and plastically deform. The impact diverts the energy associated with a moving vehicle into energy that deforms vehicle structures. The vehicle structures may be designed to accommodate such impact events, such that the energy associated with the impact may be controllably dissipated through selective and preferential deformation of the vehicle structures. In order to inhibit unintended movement of the door interior handle 20 toward the unlatched configuration of the door latch assembly 22 during such movement of the vehicle door structures, the spring module 32 is provided.

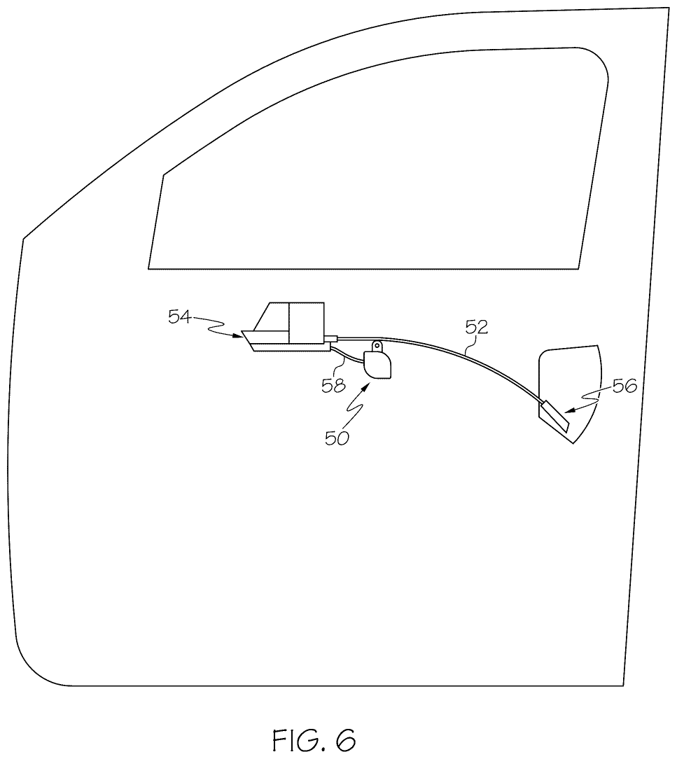

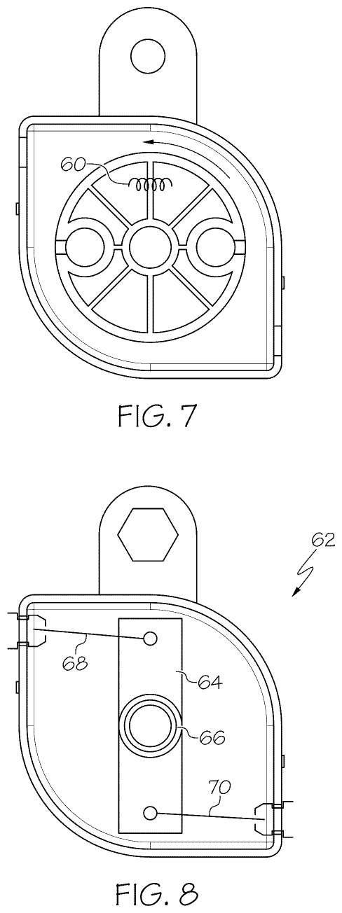

FIG. 1 shows an embodiment where the spring module 32 is in-line with the cables 28 and 30 connecting the door interior handle 20 to the door latch assembly 22, other arrangements are possible. For example, referring to FIG. 6, a spring module 50 is shown out-of-line with a cable 52 that operatively connects a door interior handle 54 to a door latch assembly 56. In this case, the spring module 50 is connected to the door interior handle 54 by another cable 58. Further, while a torsion spring is discussed above, any suitable spring type can be used, such as a compression spring 60, which is diagrammatically illustrated by FIG. 7. FIG. 8 shows an embodiment of a spring module 62 that uses a lever 64 to transfer force from a spring 66 to cables 68 and 70.

The above-described vehicle door assemblies include a door latch assembly, a door interior handle, a primary spring that provides a first level of biasing force to the door interior handle and a spring module that provides an additional, second level of biasing force thereby increasing the total biasing force to the door interior handle to hold the door interior handle in an initial position. The primary spring may be limited in spring rate due to packaging and handle strength. This spring module can be added to vehicles as necessary and can be adopted as a standard part for rapid deployment in the event of an unexpected door opening late in development/testing. In some embodiments, the spring module may be installed after vehicle manufacture, for example, if there becomes a need to increase the bias force on the door interior handle.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A vehicle comprising:
a vehicle door assembly comprising:
a door interior handle assembly including a primary spring that biases a door interior handle toward a latched position;
a door latch assembly;
one or more cables where at least one cable of the one or more cables operably connects the door interior handle to the door latch assembly; and
a spring module operably connected to the door interior handle by the one or more cables such that the spring module provides a secondary biasing force that biases the door interior handle toward the latched position.

2. The vehicle of claim 1, wherein the at least one cable is a first cable that extends between the spring module and the door latch assembly, the one or more cables comprising a second cable that extends between the spring module and the door interior handle.

3. The vehicle of claim 1, wherein the at least one cable is a first cable that extends between the door interior handle and the door latch assembly, the one or more cables comprising a second cable that extends between the spring module and the door interior handle.

4. The vehicle of claim 1, wherein the spring module comprises an outer casing and a secondary spring located in the casing that is configured to bias the at least one cable.

5. The vehicle of claim 4, wherein the secondary spring is configured to bias a cable drum located in the outer casing, the at least one cable wound around the cable drum.

6. The vehicle of claim 4, wherein the secondary spring is configured to bias a lever located in the outer casing, the at least one cable connected to the lever.

7. The vehicle of claim 4, wherein the secondary spring is a torsion spring or a compression spring.

8. A method of controlling unlatching of a door latch assembly of a vehicle door assembly, the method comprising:
connecting a spring module to at least one cable, the at least one cable operably connecting to a door interior handle including a primary spring that biases a door interior handle toward a latched position, the spring module configured to provide a secondary biasing force that biases the door interior handle toward a latched position; and
mounting the spring module inside the vehicle door assembly.

9. The method of claim 8, wherein the at least one cable is a first cable that extends between the spring module and the door interior handle, the one or more cables comprising a second cable that extends between the spring module and the door latch assembly.

10. The method of claim 8, wherein the at least one cable is a first cable that extends between the door interior handle and the spring module, the at least one cable comprising a second cable that extends between the door interior handle and the door latch assembly.

11. The method of claim 8, wherein the spring module comprises an outer casing and a secondary spring located in the casing biasing the at least one cable.

12. The method of claim 11, wherein the secondary spring biasing a cable drum located in the outer casing, the at least one cable wound around the cable drum.

13. The method of claim 11, wherein the secondary spring biasing a lever located in the outer casing, the at least one cable connected to the lever.

14. The method of claim 11, wherein the secondary spring is a torsion spring or a compression spring.
